(19) United States
(12) Patent Application Publication
(10) Pub. No.: US 2010/0009191 A1
(43) Pub. Date: Jan. 14, 2010

(54) FINE SILVER PARTICLES, PRODUCTION METHOD THEREOF, AND PRODUCTION APPARATUS THEREFOR

(75) Inventors: Kanji Kuba, Iwaki (JP); Akihiro Higami, Iwaki (JP); Takahiro Uno, Iwaki (JP)

Correspondence Address: DARBY & DARBY P.C., P.O. BOX 770, Church Street Station, New York, NY, 10008-0770, US

(73) Assignee: Mitsubishi Materials Corporation, Tokyo (JP)

(21) Appl. No.: 12/375,054

(22) PCT Filed: Jul. 27, 2007
(86) PCT No.: PCT/JP2007/064793

§ 371 Date: Jan. 26, 2009

(30) Foreign Application Priority Data
Jul. 28, 2006 (JP) 2006-206742
Jul. 28, 2006 (JP) 2006-206743

(51) Int. Cl. B32B 5/16; C01B 21/00

(52) U.S. Cl. 428/402; 423/351

(57) ABSTRACT

A method for producing fine silver particles which is characterized by making an aqueous silver ammine complex solution and a reducing agent solution come in contact with each other in an open space to reduce the silver ammine complex and deposit fine silver particles, either in which the contacting is conducted by (i) a method of spraying an aqueous silver ammine complex solution and a reducing agent solution through nozzles or (ii) a method of discharging an aqueous silver ammine complex solution and a reducing agent solution from obliquely downward nozzles opposite to each other to thereby produce fine silver particles which are free from coarse particles having particle sizes of 5 μm or more and have a mean particle size of primary particles of 0.08 to 1.0 μm and crystallite sizes of 20 to 150 nm or in which an aqueous silver ammine complex solution having a silver concentration of 20 to 180 g/L and an organic reducing agent solution having a reducing agent concentration of about 0.6 to about 1.4 times the silver concentration by reaction equivalent are used to thereby stably produce fine silver particles having a mean particle size of primary particles of 0.05 to 1.0 μm and crystallite sizes of 20 to 150 nm.

### TECHNICAL FIELD

The present invention relates to fine silver particles excellent in terms of dispersibility and having adequate particle size. More specifically, the present invention relates to fine silver particles having a suitable particle size and high dispersibility to be used as a paste component for forming a wiring material or electrode material of an electronic device, and also relates to a method for producing the particles.

Priority is claimed on Japanese Patent Application No. 2006-206742 and Japanese Patent Application No. 2006-206743, filed Jul. 28, 2006, the contents of which are incorporated herein by reference.

### BACKGROUND ART

In recent years, electronic devices that are smaller and have higher density are required in order to achieve high performance electronic appliances. Accordingly, fine silver particles that are used in the paste materials for forming these devices are also required to have finer particle size and higher dispersibility so as to achieve finer wires and electrodes.

As a method for producing the silver particles used in a material of electronic appliances, a method is conventionally known in which silver particles are deposited by reducing an ammine complex of a silver salt, and the deposited particles are then washed and dried to obtain silver particles having a mean particle size of about a few micrometers (Patent Documents 1 and 2). However, it has been difficult to stably obtain silver particles having a mean particle size of 1 μm or less with this method. Moreover, in this method, the particle size distribution becomes wide and the particles easily agglomerate. Therefore, it has been difficult to produce fine silver particles having a uniform particle size of 1 μm or less with the above production method.

In addition, a method is known in which a solution of an organic reducing agent is mixed with an aqueous silver ammine complex solution by introducing the former solution in a midst of a flow path of the latter solution so as to reduce silver and obtain fine silver particles having a small crystallite size in a conduit (Patent Documents 3 and 4). However, since the reduction of a silver ammine complex is carried out in a conduit with this method, the flow path becomes narrow due to the deposition of silver, and the release of pieces of deposited silver from the conduit wall resulting in the mixing of some coarse silver particles within the fine silver particles has also been a problem. Further, the production efficiency of the method is low due to the use of an aqueous silver ammine complex solution with an extremely low silver concentration.

[Patent Document 1] Japanese Unexamined Patent Application, First Publication No. Hei 8-134513

[Patent Document 2] Japanese Unexamined Patent Application, First Publication No. Hei 8-176620

[Patent Document 3] Japanese Unexamined Patent Application, First Publication No. 2005-48236

[Patent Document 4] Japanese Unexamined Patent Application, First Publication No. 2005-48237

### DISCLOSURE OF THE INVENTION

### Problems to be Solved by the Invention

The present invention provides a method for producing fine silver particles which solves the abovementioned problems associated with the conventional methods, and the fine silver particles produced by this method. According to a first aspect of the production method of the present invention, it becomes possible to efficiently produce fine silver particles having adequate particle size and satisfactory dispersibility without causing the incorporation of deposited coarse particles within the fine silver particles. Further, according to a second aspect of the production method of the present invention, it becomes possible to efficiently produce fine silver particles having adequate particle size and satisfactory dispersibility by using an aqueous silver ammine complex solution with high silver concentration.

### Means for Solving the Problems

According to the present invention, a method for producing fine silver particles which solves the abovementioned problems and the fine silver particles produced by this method are provided by the following requirements.
(1) Fine silver particles produced by the reduction of a silver ammine complex which are characterized in that a mean particle size of primary particles thereof is within a range of 0.08 μm to 1.0 μm; a crystallite size thereof is within a range of 20 nm to 150 nm; and the particles are free from coarse particles having a particle size of 5 μm or more.
(2) A method for producing fine silver particles which is a method for producing fine silver particles by reducing a silver ammine complex, the method including the steps of: reducing the silver ammine complex by making an aqueous silver ammine complex solution and a reducing agent solution come in contact with each other in an open space; and depositing fine silver particles.
(3) The method for producing fine silver particles according to the above (2) characterized in that the aqueous silver ammine complex solution and the reducing agent solution are sprayed from nozzles that are facing each other while forming a predetermined angle therebetween so that these solutions are mixed outside the nozzles, thereby reducing the silver ammine complex outside the nozzles and depositing fine silver particles.
(4) The method for producing fine silver particles according to the above (2) characterized in that the aqueous silver ammine complex solution and the reducing agent solution are discharged from nozzles that are arranged opposite to each other while extending obliquely downward so that these solutions are mixed below the nozzles, thereby reducing the silver ammine complex and depositing fine silver particles.
(5) The method for producing fine silver particles according to the above (2) or (4) characterized in that an aqueous silver ammine complex solution having a silver concentration of 20 to 180 g/L and an organic reducing agent solution having a reducing agent concentration of 6 to 130 g/L are used.
(6) An apparatus for producing fine silver particles characterized by having nozzles that are arranged opposite to each other while extending obliquely downward; a mixing system in which an aqueous silver ammine complex solution is discharged from one nozzle and a reducing agent solution is discharged from another so as to mix these solutions; a supply unit that supplies the aqueous silver ammine complex solution and the reducing agent solution to the respective nozzles; and a receiving tank that receives the solutions discharged from the nozzles; and in which the aqueous silver ammine complex solution and the reducing agent solution discharged from the nozzles are mixed below the nozzles to deposit fine silver particles.
(7) The apparatus for producing fine silver particles according to the above (6) further including a unit for adjusting an angle between the nozzles; a unit for adjusting a distance between the nozzles; and a unit for adjusting a flow rate of solutions discharged from the nozzles.
(8) The apparatus for producing fine silver particles according to the above (6) or (7) in which an outlet of each of the nozzles has either a cylindrical shape or a slit shape.
(9) A method for producing fine silver particles which is a method for producing fine silver particles by reducing a silver ammine complex and depositing fine silver particles, the method characterized by having the steps of: adding an alkali substance to a reducing agent solution; and mixing the reducing agent solution with an aqueous silver ammine complex solution within a region where an oxidation-reduction potential of the reducing agent solution is stable, thereby depositing fine silver particles.
(10) The method for producing fine silver particles according to the above (9) characterized in that the region where an oxidation-reduction potential of the reducing agent solution is stable corresponds to a region that ranges from a point where an oxidation-reduction potential of the reducing agent solution is 0.02 V (vs. Ag/AgCl) higher than a minimum value of the oxidation-reduction potential; down to the minimum value; and then up to a range where the oxidation-reduction potential remains relatively constant.
(11) The method for producing fine silver particles according to the above (9) or (10) characterized in that the aqueous silver ammine complex solution having a silver concentration of 20 to 180 g/L and an organic reducing agent solution having a reducing agent concentration of about 0.6 to about 1.4 times the silver concentration by reaction equivalent are used.
(12) The method for producing fine silver particles according to any one of the above (9) to (11) in which fine silver particles having a mean particle size of primary particles within a range of 0.05 μm to 1.0 μm and crystallite size within a range of 20 nm to 150 nm are deposited.
(13) The method for producing fine silver particles according to any one of the above (9) to (12) further including the step of: recovering deposited fine silver particles; and subjecting recovered particles to an alkali cleaning process at a pH of 10 to 15, thereby reducing organic impurities to 0.8 wt.% or less based on a carbon content.

### EFFECTS OF THE INVENTION

In the production method according to the first aspect of the present invention, an aqueous silver ammine complex solution and a reducing agent solution are mixed outside the conduits where these solutions flow, so that fine silver particles deposit in an open space without any provision of an object to attach to, and the incorporation of coarse particles within the fine particles is prevented. As a result, fine silver particles having a uniform particle size can be obtained.

The fine silver particles of the present invention are fine silver particles having a mean particle size of primary particles within a range of 0.08 μm to 1.0 μm, a crystallite size within a range of 20 nm to 150 nm, and satisfactory dispersibility and free from coarse particles with a particle size of 5 μm or more therein. The fine silver particles can be suitably used in the paste materials for forming finer wires and electrodes of electronic appliances.

In addition, in the production method according to the first aspect and the production apparatus of the present invention, the production efficiency of fine silver particles is satisfactory since an aqueous silver ammine complex solution with an adequate silver concentration is used. Moreover, maintenance of the apparatus is easy since fine silver particles do not deposit in the solution conduit, thereby preventing the clogging of solution conduits.

In the production method according to the first aspect of the present invention, for example, the following methods are included as specific processes for reducing a silver ammine complex by mixing an aqueous solution of the silver ammine complex and a reducing agent solution in an open space and depositing fine silver particles: (i) a method in which the aqueous solution of the silver ammine complex and the solution of the reducing agent are sprayed from nozzles so that these solutions are mixed outside the nozzles, thereby depositing fine silver particles [spray mixing method]; and (ii) a method in which the aqueous solution of the silver ammine complex and the solution of the reducing agent are discharged from nozzles that are arranged opposite to each other while extending obliquely downward so that these solutions are mixed below the nozzles, thereby depositing fine silver particles [discharge mixing method]. The fine silver particles with the abovementioned particle size can be obtained by any of these methods.

According to the production method of the first aspect and the production apparatus of the present invention, the particle size and the like of fine silver particles can be controlled by adjusting the angle and distance between the nozzles, spray rate or discharge rate, or the like, and thus fine silver particles having a desired particle size can be produced efficiently. Moreover, the productivity of fine silver particles can be enhanced by using nozzles with a slit shaped outlet.

Further, according to the production method of the second aspect of the present invention, a reducing agent solution is first prepared by the addition of an alkali substance thereto, and while monitoring the oxidation-reduction potential (hereinafter referred to as ORP) of the solution of the reducing agent, the resulting reducing agent solution is mixed with an aqueous silver ammine complex solution within a region where the ORP of the reducing agent solution remains stable. As a result, fine silver particles having a desired particle size can be produced efficiently. Specifically, fine silver particles having a mean particle size of primary particles within a range of 0.05 μm to 1.0 μm and a crystallite size within a range of 20 nm to 150 nm can be produced efficiently.

The particle size of the fine silver particles that are deposited by reduction is greatly affected by the abovementioned ORP value. In the conventional methods for producing fine silver particles, the production of fine silver particles is largely conducted based on the pH control of solutions for the production. However, for some certain period of time after the preparation of the reducing agent solution, a fluctuation region exists where the values of ORP decline rapidly, although pH values remain stable. When the reduction of silver is conducted during this time period by mixing the reducing agent solution and an aqueous solution of a silver ion solution, the particle size of the fine silver particles that are deposited by reduction fluctuates, thereby making it difficult to efficiently obtain fine silver particles with a desired particle size.

Further, according to the production method of the second aspect of the present invention, fine silver particles with small particle size can be obtained as compared to the conventional production methods even when a highly concentrated silver ion solution is used. For depositing fine silver particles having a particle size of around 0.5 μm or less with the conventional methods, a silver ammine complex solution or the like having a silver concentration of a few grams/L to about 50 g/L has been used. On the other hand, according to the production method of the second aspect of the present invention, fine silver particles with the abovementioned particle size can be obtained even when a silver ammine complex solution having a silver concentration of about 50 g/L or more is used, and the yield of obtained fine silver particles is also higher. Therefore, according to the second aspect of the production method of the present invention, it becomes possible to produce fine silver particles with more satisfactory productivity and small particle size as compared to those obtained with the conventional production methods.

### BRIEF DESCRIPTION OF THE DRAWINGS

FIG. 1 is a schematic diagram of a production apparatus according to the present invention.

FIG. 2 is a schematic diagram showing a nozzle with a slit shaped outlet.

FIG. 3 is an explanatory diagram showing an angle formed between nozzles and distance between nozzles.

FIG. 4 is an electron micrograph of fine silver particles in a sample A6 obtained in Example 1.

FIG. 5 is a graph showing changes in an oxidation-reduction potential of a reducing agent solution.

### DESCRIPTION OF THE REFERENCE SYMBOLS

1: Nozzle; 2: Nozzle; 3: Storage tank; 4: Storage tank; 5: Conduit; 6: Conduit; 7: Solution supply pump; 8: Solution supply pump; 9: Adjusting section; 10: Adjusting section; 11: Receiving tank; θ: Angle formed between nozzles; L: Distance between nozzles; d: Slit gap width; and w: Slit length.

### BEST MODE FOR CARRYING OUT THE INVENTION

Fine silver particles, the production method thereof, and production apparatus therefor according to the present invention will be specifically described below.

The production method according to the first aspect of the present invention which is a method for producing fine silver particles by reducing a silver ammine complex is specifically a method in which an aqueous silver ammine complex solution and a reducing agent solution are mixed outside the conduits of these solutions, thereby reducing the silver ammine complex in an open space and depositing fine silver particles.

In the production method according to the first aspect of the present invention, fine silver particles are deposited in an open space outside the solution conduits. Accordingly, there will be no object provided for the fine silver particles to attach to, and thus the production of coarse particles is prevented. Therefore, it becomes possible to obtain fine silver particles in which no coarse particles having a particle size of 5 μm or more are included.

In the production method according to the first aspect of the present invention, fine silver particles can be deposited continuously since the aqueous silver ammine complex solution and the reducing agent solution come in contact while flowing to mix these solutions. In addition, it becomes possible to continuously deposit silver fine particles having a mean particle size of primary particles within a range of 0.08 μm to 1.0 μm and a crystallite size within a range of 20 nm to 150 nm by adjusting various conditions such as the concentration, flow rate, and flow pressure of the above solutions, an aperture of nozzles, an angle formed between nozzles, and the distance between nozzles. Further, the fine silver particles produced by the method according to the present invention have satisfactory dispersibility, exemplified by their degree of agglomeration, which is 1.7 or less.

The mean particle size D1 of primary particles can be measured by observation using a scanning electron microscope (SEM). The crystallite size can be measured by X-ray diffraction analysis or the like. Further, the degree of agglomeration G can be shown by the ratio between the mean particle size D50, which is a particle size at 50% weight accumulation obtained by a laser diffraction scattering particle size distribution measurement method, and the abovementioned mean particle size D1 of primary particles. In other words, G can be expressed by the formula: G=D50/D1. The terms “mean particle size of primary particles”, “crystallite size”, and “degree of agglomeration” used in the present invention refer to the values obtained by these measuring methods.

Specifically, the mixing of the aqueous silver ammine complex solution and the reducing agent solution in an open space and the deposition of fine silver particles can be conducted by the following process, for example.

(i) A method in which the aqueous silver ammine complex solution and the reducing agent solution are sprayed from nozzles that are facing each other while forming a predetermined angle therebetween, so that these solutions are mixed outside the nozzles, and thereby depositing fine silver particles [spray mixing method]; and

(ii) A method in which the aqueous silver ammine complex solution and the reducing agent solution are discharged from nozzles that are arranged opposite to each other while extending obliquely downward so that these solutions are mixed below the nozzles, thereby depositing fine silver particles [discharge mixing method]. In the latter method, instead of spraying the solutions for collision, the solutions are discharged from the respective nozzles so that they mix naturally while flowing downwards. Since the solutions discharged from the nozzles do not splash about or receive any impact due to the spraying, the yield of fine particles is satisfactory and spherical particles can be readily obtained with the latter method.

In the spray mixing method, the aqueous silver ammine complex solution and the reducing agent solution are atomized for mixing so as to have a droplet size of a few tens of micrometers. Accordingly, the space where the reaction takes place will be limited, and thus the size of produced particles will become even smaller. On the other hand, since the discharge mixing method does not require any spraying units or units for covering the spraying space, the configuration of an apparatus used for the method will be simple, and also the amount of throughput can easily be scaled up.

In the production method according to the first aspect of the present invention, an adequate silver concentration of the aqueous silver ammine complex solution is 20 to 180 g/L in both the spray mixing method and discharge mixing method. This aqueous silver ammine complex solution can be prepared by mixing an aqueous ammonia solution with a silver nitrate solution having a silver concentration of 34 to 200 g/L. An organic reducing agent such as hydroquinone or ascorbic acid can be suitably used as a reducing agent. An adequate concentration of the reducing agent is 6 to 130 g/L.

Among the conventional production methods, methods are known in which an aqueous silver ammine complex solution with a silver concentration of 1 to 6 g/L and a hydroquinone solution with a concentration of 1 to 3 g/L are used (Patent Documents 1 and 2). However, with these methods using solutions having low silver concentrations, there is a problem of low production efficiency since the amount of deposited fine silver particles is small. On the other hand, the production efficiency of the production method according to the present invention is satisfactory since the adopted silver concentration is about 4 times to about 180 times as high as that of the above conventional methods.

In the abovementioned spray mixing method of the present invention, the amount of sprayed silver ammine complex solution is preferably within a range of 0.1 to 10 L/min, and likewise, the amount of sprayed organic reduced agent solution is preferably within a range of 0.1 to 10 L/min. The size of the sprayed droplets is preferably within a range of 5 to 100 μm. When the amount of spray is smaller than the above range, the processing speed will be low, which results in lower efficiency. On the other hand, when the amount of spray exceeds the abovementioned range, a wider space for spraying will be required. Moreover, when the size of the sprayed droplets is smaller than the abovementioned range, the amount of spray needs to be reduced, resulting in low productivity and difficulty in recovery of fine particles. On the other hand, when the size of the sprayed droplets is too large, the particle size of the obtained particles will not be adequately small, and thus the advantage of the spray mixing method is not exploited. Nozzle apertures, angles formed between nozzles, spray pressure, spray amount, or the like is adjusted in order to make the size of the droplets within the abovementioned range. Fine spherical particles can be obtained according to the spray mixing method of the present invention. Specifically, for example, the solutions are sprayed from the nozzles that are facing each other and forming an angle of 90° therebetween in a spray amount of 0.1 to 10 L/min, while the nozzle aperture and the distance between the nozzles are adjusted so as to achieve the abovementioned droplet size.

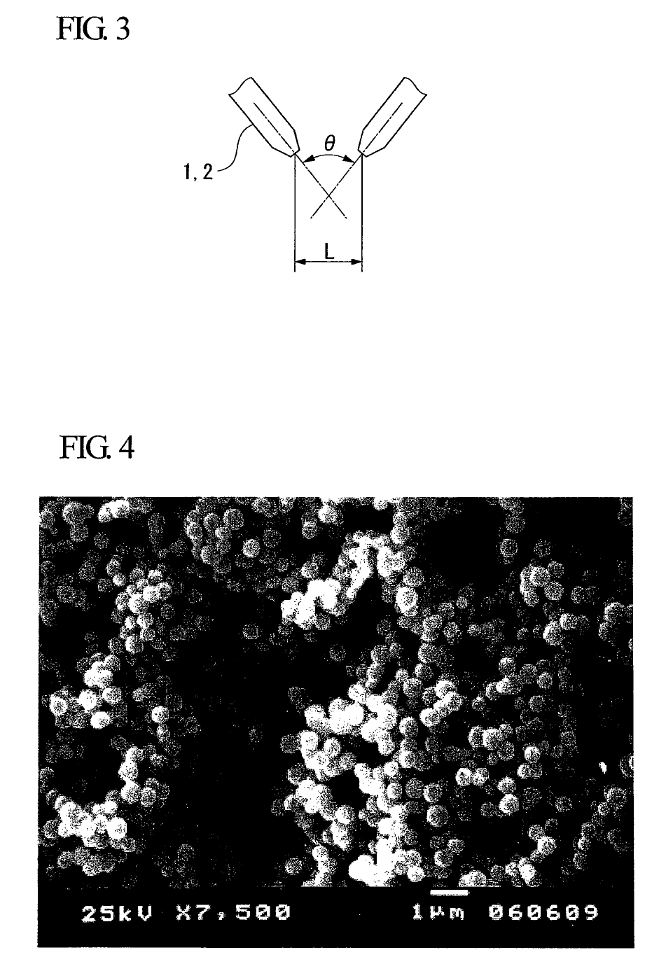

In the discharge mixing method of the present invention, it is possible to use a nozzle with a slit shaped outlet, as well as a nozzle with a cylindrical shaped outlet. Since the flow rate of solutions can be increased by using nozzles with a slit shaped outlet, the productivity of fine silver particles can be enhanced. The discharge mixing method is suitable for obtaining fine spherical particles. FIG. 2 shows a nozzle with a slit-shaped outlet. Further, FIG. 3 shows an angle θ formed between nozzles and distance L between nozzles in the discharge mixing method. The nozzle in FIG. 3 may have either a cylindrical-shaped outlet or a slit-shaped outlet.

When using a nozzle with a cylindrical-shaped outlet, the angle formed between nozzles (the angle formed between the discharge directions of the solutions; i.e., the angle θ in the drawing) is preferably within a range of 45° to 70°. In addition, nozzle apertures of 1 to 50 mm are adequate, and the flow rate of solutions discharged from the nozzles is preferably within a range of 1 to 20 L/min. An adequate distance between nozzles is 0.5 to 5 mm. When these conditions fall beyond the abovementioned ranges, it becomes difficult to stably deposit fine silver particles having a mean particle size of primary particles within a range of 0.08 μm to 1.0 μm and a crystallite size within a range of 20 nm to 150 nm.

When using a nozzle with a slit-shaped outlet, it is preferable that a slit gap width d be within a range of 0.2 to 50 mm and a slit length w be within a range of 10 to 200 nm. In addition, the angle formed between nozzles (the angle formed between the discharge directions of the solutions; i.e., the angle θ in the drawing) is preferably within a range of 45° to 70°, the flow rate of solutions discharged from the nozzles is preferably within a range of 1 to 20 L/min, and the distance between nozzles is preferably within a range of 0.5 to 5 mm.

In the discharge mixing method, conditions such as the flow pressure of solutions may be adjusted while maintaining the angle formed between nozzles, the distance between nozzles, nozzle apertures, and slit gap width within the abovementioned ranges, so that the silver fine particles having a mean particle size of primary particles within a range of 0.08 μm to 1.0 μm and a crystallite size within a range of 20 nm to 150 nm are achieved, whether the nozzles have a cylindrical shaped outlet or a slit shaped outlet. By the abovementioned requirements, it becomes possible to stably produce fine silver particles in which no coarse particles having a particle size of 5 μm or more are substantially included.

Both the spray mixing method and discharge mixing method described above do not require the use of a dispersant. In addition, in either method, it is preferable to recover the deposited fine silver particles and to remove the organic matter on the particle surface by alkali cleaning.

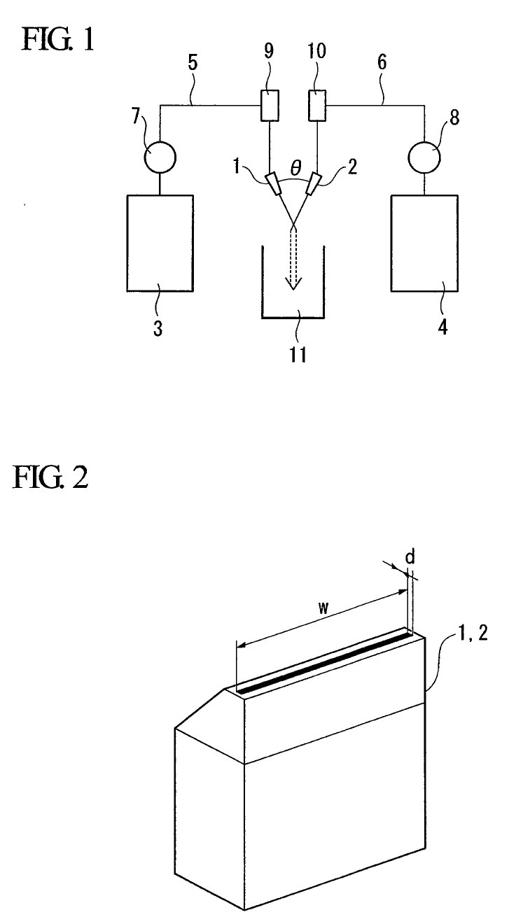

FIG. 1 shows one example of a configuration of an apparatus used for conducting the production method according to the first aspect of the present invention (apparatus configuration based on the descriptions on the discharge mixing method). As shown in the drawing, the production apparatus of the present invention includes: nozzles 1 and 2 that are arranged opposite to each other while extending obliquely downward; a storage tank 3 for an aqueous silver ammine complex solution; a storage tank 4 for a reducing agent solution; conduits 5 and 6 for supplying solutions from the storage tanks 3 and 4 to the nozzles 1 and 2; solution supply pumps 7 and 8 that are provided within the conduits 5 and 6, respectively; adjusting sections 9 and 10 that are provided between the solution supply pump 7 and the nozzle 1 and between the solution supply pump 8 and the nozzle 2, respectively; and a receiving tank 11 provided below the nozzles 1 and 2.

In the illustrated apparatus, it is preferable that it be configured so that the angle θ formed between the nozzles 1 and 2, the distance L between the nozzles, and the flow rate and flow pressure of solutions discharged from the nozzles be adjustable. By adjusting the angle θ formed between the nozzles 1 and 2, the distance L between the nozzles, or the flow rate and flow pressure of solutions discharged from the nozzles, it becomes possible to control the size, shape, or the like of the deposited fine silver particles.

Specifically, for example, by reducing the angle θ formed between the nozzles to increase the distance L between the nozzles, and adjusting the flow pressure to reduce the flow rate of solutions, the particle size of the resulting fine silver particles tends to become larger and the particle size distribution tends to widen. On the other hand, by increasing the angle θ formed between the nozzles to reduce the distance L between the nozzles, and increasing the flow rate of solutions, the particle size of the resulting fine silver particles tends to become smaller and the particle size distribution tends to become narrower.

Next, the production method according to the second aspect of the present invention will be described.

The production method according to the second aspect of the present invention is a method for producing fine silver particles by reducing a silver ammine complex and depositing fine silver particles, the method characterized by having the steps of: adding an alkali substance to a reducing agent solution; and thereafter mixing the solution of the reducing agent with an aqueous silver ammine complex solution within a region where an oxidation-reduction potential of the solution of the reducing agent is stable, thereby depositing fine silver particles.

As a wet production method for producing fine silver particles, a method is known in which an aqueous silver ammine complex solution is prepared by adding an aqueous ammonia solution to a silver nitrate solution, and a reducing agent is then added to the resulting solution, thereby reducing the silver ammine complex and depositing fine silver particles. In this method, an organic reducing agent such as hydroquinone is used as the reducing agent. Moreover, an alkali substance such as sodium hydroxide is usually added to the solution of the reducing agent to adjust the pH during the reduction process, thereby adjusting the pH of the solution of the reducing agent within a range of 11 to 12.

In such solutions of reducing agents where an alkali substance such as sodium hydroxide is added, the following phenomena are observed. That is, the oxidation-reduction potential (ORP) of the solution rapidly declines immediately after the addition of alkali substance, even if the pH of the solution remains between 11 and 12, and the ORP values drop further and reach their minimum about 60 to about 90 minutes after the addition of alkali substance. Thereafter, the ORP values slightly increase and reach a stationary phase where the ORP values remain constant for a few hours. FIG. 5 shows a specific example of changes in the ORP value of a reducing agent solution.

FIG. 5 is a graph showing changes in the ORP value with time after the addition of an alkali substance regarding the reducing agent solution formed by adding 1.6 L of an aqueous sodium hydroxide solution having a concentration of 14.3 mol/L to 20 L of a hydroquinone solution having a concentration of 0.48 mol/L. A change in the ORP value is shown together with the changes in pH and temperature of the solution. In the example shown in FIG. 5, the ORP value rapidly declines immediately after the addition of an alkali substance, reaches a value of about −0.6 V (vs., Ag/AgCl; the same applies hereafter) about 60 minutes after the addition, drops even further and reaches its minimum (about −0.62 V) about 90 minutes after the addition, and thereafter enters a stationary phase where the ORP value gradually increases slightly, and as a result, the ORP value returns to about −0.6 V about 6 hours after the addition. In the solutions of a reducing agent, it should be noted that the degree of changes in the ORP value largely depends on the concentration of the reducing agent, whereas the mode of changes in the ORP value largely depends on the concentrations of reducing agent and alkali substance.

As described above, the period from immediately after the addition of an alkali substance to the reducing agent solution to about 90 minutes after the addition can largely be described as a fluctuation phase, where the ORP value rapidly declines. When the reducing agent solution obtained from this phase is mixed with an aqueous silver ammine complex solution, the particle size of the deposited fine silver particles tends to become heterogeneous since the reaction for reducing the silver ammine complex is affected by the changes in ORP.

Accordingly, in the production method of the present invention, fine silver particles are stably deposited as follows: Regarding the reducing agent solution where an alkali substance is added, instead of collecting the solution in the fluctuation phase in which the ORP value changes considerably, the solution in the stationary phase in which the ORP value remains stable is collected, followed by the mixing of the solution with the aqueous silver ammine complex solution.

The abovementioned stationary phase of the ORP values ranges from a point immediately before the ORP minimum value to the beginning of the fluctuation phase which follows. For example, the stationary phase begins from a point which is 0.02 V (vs., Ag/AgCl) higher than the abovementioned minimum value and includes the minimum value as well as a region where the ORP value remains largely constant but gradually and slightly increases to bounce back. Note that the region including the ORP minimum value and in which the ORP value gradually bounces back will be referred to as a “relatively constant region”. In the example shown in FIG. 5, the relatively constant region corresponds to a region which follows the addition of an alkali substance by about 60 minutes.

By conducting the reduction of silver within the abovementioned stationary phase of the ORP value, it becomes possible to stably deposit fine silver particles even when the aqueous silver ammine complex solution has a relatively high silver concentration. Specifically, for example, fine silver particles having a mean particle size of primary particles within a range of 0.05 μm to 1.0 μm and a crystallite size within a range of 20 nm to 150 nm can be stably deposited by using an aqueous silver ammine complex solution having a silver concentration of 20 to 180 g/L. When the silver concentration is lower than 20 g/L, the production efficiency declines as in the conventional methods. On the other hand, it is not preferable when the silver concentration is higher than 180 g/L because the particle size of fine silver particles becomes larger and the particles tend to agglomerate.

In the above reduction reaction, an appropriate concentration of a reducing agent is about 0.6 to about 1.4 times the silver concentration by reaction equivalent (namely, about 6 to about 107 g/L). It is preferable to use hydroquinone, pyrogallol, 3,4-dihydroxytoluene, or the like as a reducing agent.

It is preferable that the deposited fine silver particles be recovered and subjected to an alkali cleaning process at a pH within a range of 10 to 15. An aqueous ammonia solution, an aqueous sodium hydroxide solution, an aqueous potassium hydroxide solution, or the like can be suitably used as an alkali substance. Benzoquinone or the like which is attached to the surface of fine silver particles is removed by the alkali cleaning process, and thus fine silver particles with a low organic impurity content can be obtained. Specifically, for example, fine silver particles with organic impurities of 0.8 wt. % or less based on a carbon content can be obtained due to the alkali cleaning process.

According to the second aspect of the production method of the present invention, fine silver particles having a mean particle size of primary particles within a range of 0.05 μm to 1.0 μm and a crystallite size within a range of 20 nm to 150 nm can stably be obtained, and the fine silver particles can be suitably used to form a wiring material or electrode material for achieving finer electronic devices with higher density.

### EXAMPLES

Examples of the present invention will be described below. In all Examples, a hydroquinone solution was used as a reducing agent solution.

### Experimental Example 1

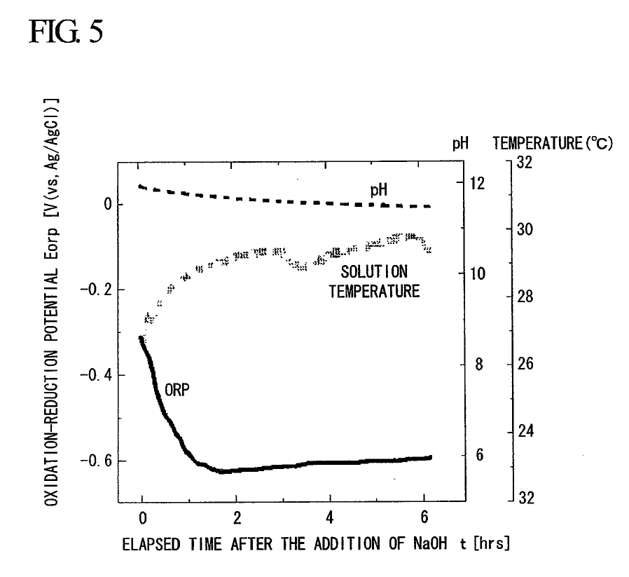

Fine silver particles were produced by the spray mixing method. The same amount of an aqueous silver ammine complex solution and the reducing agent solution were sprayed from the nozzles that were facing each other and forming an angle of about 90° therebetween, while the spray pressure and nozzle aperture were selected so as to achieve the spray amount shown in Table 1, thereby mixing the solutions. Conditions for the particle production as well as results are shown in Table 1. In addition, an electron micrograph (magnification: ×7,500) of fine silver particles in a sample A6 is shown in FIG. 4.

### Experimental Example 2

Fine silver particles were produced by the discharge mixing method using a nozzle with a cylindrical shaped outlet. An aqueous silver ammine complex solution and the reducing agent solution which had concentrations shown in Table 2 were discharged at the same flow rate from the nozzles facing each other and having an angle and distance shown in Table 2 therebetween, thereby mixing the solutions. Conditions for the particle production as well as results are shown in Table 2.

### Experimental Example 3

Fine silver particles were produced by the discharge mixing method using nozzles with a slit shaped outlet (slit gap width d=0.5 mm or 10 mm; slit length w=50 mm or 150 mm). An aqueous silver ammine complex solution and the reducing agent solution which had concentrations shown in Table 3 were discharged at the same flow rate from the nozzles facing each other and having an angle and distance shown in Table 3 therebetween, and the solutions were mixed as a result. Conditions for the particle production as well as results are shown in Table 3.

The mean particle size D1 of primary particles was measured by dividing the sum of diameters of all the particles by the total number of particles, based on the assumption that the particles observed in electron micrographs were not agglomerated. In addition, as for the plurality of overlapping particles in the electron micrographs, their diameters were calculated by interpolation from the curvatures of visible portions. The degree of agglomeration G was measured, based on the mean particle size D1 of primary particles and the particle size D50 determined by the aforementioned laser diffraction scattering method, using the formula: G=D50/D1.

As shown in Tables 1 to 3, according to the production method of the present invention adopting either the spray mixing method or the discharge mixing method, it was possible to obtain spherical silver particles having a crystallite size within a range of 20 nm to 150 nm, primary particles with a mean particle size within a range of 0.1 to 1.0 μm, and the degree of agglomeration of 1.7 or less, at a yield of 98% or more without including coarse particles having a particle size of 5 μm or more.

On the other hand, the samples B1 and B3 to B5 shown in Table 1 had a low yield of silver particles, and spherical silver particles were not obtained in the sample B2. Moreover, a large amount of organic impurities were observed in the sample B6 due to the high concentration of the reducing agent. As shown in Table 2, coarse particles were produced in the sample B11 due to the small angle formed between nozzles. In the samples B12, B18 and B21, the two solutions collided with a great impact and splashed about such that the yield of silver particles markedly declined because the angle formed between nozzles was too large for the sample B12; the flow rate was too high for the sample B18, and the aperture of the nozzles was too small for the sample B21. In the samples B13 and B15, the yields of silver particles were low because of the low silver concentrations and low flow rates. In the samples B14 and B16, spherical silver particles were not obtained because of the excessive silver concentrations and excessive reducing agent contents. In the sample B17, the yield of silver particles was low because of the low flow rate. In the sample B19, the yield of silver particles markedly declined because the distance between nozzles was too small so that one solution splashed onto the end of a nozzle that was discharging the other solution, thereby clogging the nozzle. In the samples B20 and B22, spherical particles were not obtained because the angle formed between nozzles was too large for the sample B20, and the nozzle apertures were too large for the sample B22.

TABLE 1

| | Conditions for silver particle production | | | Results of silver particle production | | | | |
|---|---|---|---|---|---|---|---|---|
| | Spray amount | Silver concentration | Concentration of | Mean particle | Particle | Degree of | Yield | |
| | (L/min) | (g/L) | reducing agent(g/L) | size(μm) | shape | agglomeration | (%) | Other features |
| A1 | 0.1 | 100 | 50 | 0.32 | ∘ | 1.3 | 98 | No sample contained |
| A2 | 5 | 100 | 50 | 0.53 | ∘ | 1.3 | 100 | coarse particles |
| A3 | 10 | 100 | 50 | 0.69 | ∘ | 1.3 | 100 | having a particle size |
| A4 | 5 | 20 | 6 | 0.10 | ∘ | 1.2 | 99 | of 5 μm or more. All |
| A5 | 5 | 180 | 130 | 0.81 | ∘ | 1.6 | 100 | samples had a crystallite |
| A6 | 5 | 100 | 30 | 0.71 | ∘ | 1.5 | 100 | size within a range of 20 |
| A7 | 5 | 100 | 70 | 0.44 | ∘ | 1.2 | 100 | nm to 150 nm. |
| B1 | 0.05 | 100 | 50 | 0.48 | ∘ | 1.3 | 94 | Low productivity |
| B2 | 15 | 100 | 50 | 1.21 | x | 1.9 | 99 | |
| B3 | 5 | 10 | 6 | 0.29 | ∘ | 1.2 | 89 | Low productivity |
| B4 | 5 | 200 | 130 | 1.12 | x | 2.1 | 95 | Low productivity |
| B5 | 5 | 20 | 4 | 1.49 | x | 2.5 | 75 | Low productivity |
| B6 | 5 | 130 | 150 | 0.94 | ∘ | 1.8 | 100 | Excessive impurities |

Note:
A1 to A7 are examples where results fall within preferable ranges whereas B1 to B6 are examples where results fall beyond preferable ranges; symbols ∘ and x indicate spherical particles and agglomerated particles, respectively; degree of agglomeration is represented by dimensionless numbers; and yield is represented in percentages.

TABLE 2

| | Conditions for silver particle production | | | | | | Results of silver particle production | | | | |
|---|---|---|---|---|---|---|---|---|---|---|---|
| | Silver | Concen- | | | | | Mean | | | | |
| | Concen- | tration of | Flow | | | | particle | | | | |
| | tration | reducing | rate | θ | L | Φ | size | Particle | Degree of | Yield | |
| | (g/L) | agent (g/L) | (L/min) | (°) | (mm) | (mm) | (μm) | shape | agglomeration | (%) | Other features |
| A11 | 100 | 50 | 10 | 30 | 2.5 | 25 | 0.82 | ∘ | 1.6 | 100 | No samples contained |
| A12 | 100 | 50 | 10 | 50 | 2.5 | 25 | 0.59 | ∘ | 1.4 | 100 | coarse particles |
| A13 | 100 | 50 | 10 | 70 | 2.5 | 25 | 0.57 | ∘ | 1.3 | 100 | having a particle size |
| A14 | 100 | 50 | 1 | 50 | 2.5 | 25 | 0.85 | ∘ | 1.7 | 100 | of 5 μm or more. All |
| A15 | 100 | 50 | 20 | 50 | 2.5 | 25 | 0.55 | ∘ | 1.4 | 99 | samples had a crystallite |
| A16 | 100 | 50 | 10 | 50 | 0.5 | 25 | 0.52 | ∘ | 1.3 | 100 | size within a range of 20 |
| A17 | 100 | 50 | 10 | 50 | 5 | 25 | 0.63 | ∘ | 1.5 | 98 | nm to 150 nm. |
| A18 | 100 | 50 | 10 | 50 | 2.5 | 1 | 0.45 | ∘ | 1.3 | 100 | |
| A19 | 180 | 50 | 10 | 50 | 2.5 | 50 | 0.70 | ∘ | 1.4 | 100 | |
| A20 | 20 | 6 | 10 | 50 | 2.5 | 25 | 0.19 | ∘ | 1.3 | 100 | |
| A21 | 180 | 130 | 10 | 50 | 2.5 | 25 | 0.89 | ∘ | 1.7 | 100 | |
| B11 | 100 | 50 | 10 | 20 | 2.5 | 25 | 1.12 | Coarse | 1.9 | 100 | |
| | | | | | | | | particles | | | |
| B12 | 100 | 50 | 10 | 80 | 2.5 | 25 | 0.58 | ∘ | 2.1 | 85 | Collision of two solutions |
| B13 | 10 | 6 | 10 | 50 | 2.5 | 25 | 0.25 | ∘ | 1.3 | 95 | Low productivity |
| B14 | 200 | 130 | 10 | 50 | 2.5 | 25 | 1.35 | x | 2.3 | 100 | |
| B15 | 20 | 4 | 10 | 50 | 2.5 | 25 | 1.68 | x | 2.7 | 78 | Low productivity |
| B16 | 180 | 150 | 10 | 50 | 2.5 | 25 | 1.05 | x | 1.9 | 100 | |
| B17 | 100 | 50 | 0.5 | 50 | 2.5 | 25 | 0.98 | ∘ | 1.5 | 98 | |
| B18 | 100 | 50 | 25 | 50 | 2.5 | 25 | 0.50 | ∘ | 1.9 | 88 | Collision of two solutions |
| B19 | 100 | 50 | 10 | 50 | 0.2 | 25 | 0.58 | x | 2.5 | 50 | Clogging of nozzle |
| B20 | 100 | 50 | 10 | 50 | 7.5 | 25 | 1.23 | x | 1.8 | 100 | |
| B21 | 100 | 50 | 10 | 50 | 2.5 | 0.5 | 0.41 | ∘ | 1.6 | 82 | Collision of two solutions |
| B22 | 100 | 50 | 10 | 50 | 2.5 | 70 | 1.11 | x | 1.8 | 100 | |

Note:
A11 to A21 are examples where results fall within preferable ranges whereas B11 to B22 are examples where results fall beyond preferable ranges; θ represents angles formed between nozzles; L represents distance between nozzles; Φ represents nozzle aperture; symbols ∘ and x indicate spherical particles and agglomerated particles, respectively; degree of agglomeration is represented by dimensionless numbers; and yield is represented in percentages.

TABLE 3

| | Conditions for silver particle production | | | | | | | Results of silver particle production | | | | |
|---|---|---|---|---|---|---|---|---|---|---|---|---|
| | Silver | Concentration | | | | | | Mean | | | | |
| | Concentration | of reducing | Flow rate | | | | | particle | Particle | Degree of | | Other |
| | (g/L) | agent (g/L) | (L/min) | θ (°) | L (mm) | d (mm) | w (mm) | size (μm) | shape | agglomeration | Yield (%) | features |
| C11 | 100 | 50 | 20 | 50 | 2.5 | 10 | 50 | 0.52 | ∘ | 1.3 | 100 | |
| C12 | 100 | 50 | 15 | 50 | 2.5 | 0.5 | 150 | 0.43 | ∘ | 1.2 | 100 | |

Note:
Both samples C11 and C12 did not contain coarse particles having a particle size of 5 μm or more, and their crystallite size was within a range of 20 nm to 150 nm.

### Example 1

An aqueous silver ammine complex solution (a) having a silver concentration of 176 g/L, an aqueous silver ammine complex solution (b) having a silver concentration of 88 g/L, and an aqueous silver ammine complex solution (c) having a silver concentration of 22 g/L were prepared by adding adequate amounts of an aqueous ammonia solution having a concentration of 28 wt. % and water to a silver nitrate solution having a concentration of 38 wt. %. Meanwhile, an appropriate amount of sodium hydroxide solution was added to a hydroquinone solution having a concentration of 5.4 wt. %, and the ORP value was monitored. Solutions of a reducing agent were prepared so that the respective ORP values in the stationary phase will be those shown in Table 1. Subsequently, the abovementioned solutions of a reducing agent collected from the stationary region where the ORP values remain stable were mixed with the above aqueous solutions of silver ammine complex (a), (b), and (c) to deposit fine silver particles. The obtained fine silver particles were recovered, cleaned with an aqueous ammonia solution having a concentration of 28%, and then dried. With respect to the fine silver particles obtained as described above, the mean particle size and particle size distribution of primary particles, crystallite size, and organic impurities based on the carbon content were measured. The results are shown in Table 4.

With respect to the above fine silver particles, the mean particle size of primary particles, crystallite size, and organic impurities based on the carbon content were measured by the laser scattering method, X-ray diffraction analysis, and chemical analysis, respectively.

### Comparative Example

Fine silver particles were deposited and then subjected to the alkali cleaning process in the same manner as that in the above Example, except that the reducing agent solution used was collected immediately after the addition of an adequate amount of sodium hydroxide solution to the hydroquinone solution. The results are shown in Table 4.

As shown in Table 4, in Example 1 of the present invention, fine silver particles with a particle diameter within a certain range were obtained at high yield using solutions of a reducing agent collected from regions of various ORP values. Specifically, in the samples No. 1 to No. 11, mean particle size of the produced fine silver particles was 0.05 to 0.7 μm. Moreover, in each of the samples, the differences of the cumulative 20% particle size and the cumulative 80% particle size with respect to the mean particle size were about 0.02 to about 0.15 and, on the whole, relatively small. On the other hand, in the samples of Comparative Example prepared by the use of a reducing agent solution immediately after the addition of the sodium hydroxide solution and respectively having the ORP values shown in Table 4, the particle size of fine silver particles was heterogeneous and the mean particle size was within a range of 0.6 to 1.6 μm. That is, by the method of Comparative Example in which the reducing agent solution was collected immediately after the addition of sodium hydroxide solution before the oxidation-reduction potential (ORP) of the resulting solution reaches its minimum value, in order to achieve fine silver particles with uniform particle size, the production of fine silver particles had to be completed within a considerably short time (i.e. within a few minutes) while the ORP value remained relatively constant within a range from 0.02 V (vs. Ag/AgCl) higher than the minimum value down to the minimum value. Accordingly, the method adopted in Comparative Example was not suited to the long-term production of fine silver particles.

TABLE 4

| | Conditions for silver particle production | | | Produced fine silver particles | | | | |
|---|---|---|---|---|---|---|---|---|
| | Ag | Concentration of | | Mean | Cumulative | Cumulative | | Carbon |
| | concentration | reducing agent (reaction | ORP values (mV) at the | particle | 20% particle | 80% particle | Crystallite | content |
| No. | (g/L) | equivalent) | time of production | size(μm) | size(μm) | size(μm) | size(nm) | (wt. %) |
| 1 | 176 | 54 g/L(0.6-fold) | −620 | 0.330 | 0.230 | 0.430 | 23 | 0.69 |
| 2 | 88 g/L | 54 g/L(1.2-fold) | −560 | 0.607 | 0.426 | 0.777 | 25 | 0.78 |
| 3 | | | −570 | 0.495 | 0.345 | 0.645 | 25 | 0.77 |
| 4 | | | −600 | 0.387 | 0.267 | 0.507 | 24 | 0.75 |
| 5 | | | −620 | 0.275 | 0.195 | 0.355 | 23 | 0.75 |
| 6 | 22 g/L | 54 g/L(4.8-fold) | −340 | 0.475 | 0.335 | 0.615 | 23 | 0.80 |
| 7 | | | −360 | 0.388 | 0.268 | 0.508 | 23 | 0.80 |
| 8 | | | −380 | 0.295 | 0.205 | 0.465 | 24 | 0.79 |
| 9 | | | −400 | 0.187 | 0.314 | 0.385 | 24 | 0.78 |
| 10 | | | −450 | 0.102 | 0.072 | 0.132 | 23 | 0.78 |
| 11 | | | −620 | 0.062 | 0.042 | 0.082 | 22 | 0.78 |
| 12 | 88 g/L | 54 g/L(1.2-fold) | −340 mV (immediately | 1.525 | 1.065 | 1.985 | 25 | 0.72 |
| | | | after addition of alkali) | | | | | |
| 13 | | | −450 mV (immediately | 1.105 | 0.775 | 1.435 | 24 | 0.74 |
| | | | after addition of alkali) | | | | | |
| 14 | | | −550 mV (immediately | 0.654 | 0.454 | 0.854 | 24 | 0.74 |
| | | | after addition of alkali) | | | | | |

Note:
Samples No. 1 to No. 11 were prepared in Example; samples No. 12 to No. 14 were prepared in Comparative Example.

### INDUSTRIAL APPLICABILITY

According to the production method of the first aspect and the production apparatus of the present invention, the production efficiency of fine silver particles is satisfactory since an aqueous silver ammine complex solution with an adequate silver concentration is used. Moreover, maintenance of the apparatus is easy since fine silver particles do not deposit in the solution conduit, thereby preventing the clogging of solution conduits. In addition, according to the production method of the first aspect and the production apparatus of the present invention, the particle size and the like of fine silver particles can be controlled by adjusting the angle and distance between the nozzles, spray rate or discharge rate, or the like, and thus fine silver particles having an intended particle size can be produced efficiently.

Moreover, according to the production method of the second aspect of the present invention, a reducing agent solution is first prepared by the addition of an alkali substance thereto, and while monitoring the oxidation-reduction potential (ORP) of the solution of the reducing agent, the resulting reducing agent solution is mixed with an aqueous silver ammine complex solution within a region where the ORP of the reducing agent solution remains stable. Accordingly, fine silver particles having a desired particle size can be produced efficiently. Furthermore, according to the production method of the second aspect of the present invention, fine silver particles with small particle size can be obtained compared to the conventional production methods even when a highly concentrated silver ion solution is used.

Therefore, the present invention is highly useful in industry.

1. Fine silver particles produced by a reduction of a silver ammine complex,
wherein the primary particles having a mean particle size within a range of 0.08 to 1.0 μm; and a crystallite size within a range of 20 to 150 nm, and
the particles being free from coarse particles having a particle size of 5 μm or more.

2. A method for producing fine silver particles by reducing a silver ammine complex, the method comprising:
reducing the silver ammine complex by making an aqueous silver ammine complex solution and a reducing agent solution come in contact with each other in an open space; and
depositing fine silver particles.

3. The method for producing fine silver particles according to claim 2,
wherein the aqueous silver ammine complex solution and the reducing agent solution are sprayed from nozzles that are facing each other while forming a predetermined angle therebetween so that these solutions are mixed outside the nozzles, thereby reducing the silver ammine complex outside the nozzles and depositing fine silver particles.

4. The method for producing fine silver particles according to claim 2,
wherein the aqueous silver ammine complex solution and the reducing agent solution are discharged from nozzles that are arranged opposite to each other while extending obliquely downward so that these solutions are mixed below the nozzles, thereby reducing the silver ammine complex and depositing fine silver particles.

5. The method for producing fine silver particles according to claim 2,
wherein an aqueous silver ammine complex solution having a silver concentration of 20 to 180 g/L and an organic reducing agent solution having a reducing agent concentration of 6 to 130 g/L are used.

6. An apparatus for producing fine silver particles comprising:
nozzles that are arranged opposite to each other while extending obliquely downward;
a mixing system in which an aqueous silver ammine complex solution is discharged from one nozzle and a reducing agent solution is discharged from another nozzle so as to mix these solutions;
a supply unit that supplies the aqueous silver ammine complex solution and the reducing agent solution to the respective nozzles; and
a receiving tank that receives the solutions discharged from the nozzles, the aqueous silver ammine complex solution and the reducing agent solution discharged from the nozzles being mixed below the nozzles to deposit fine silver particles.

7. The apparatus for producing fine silver particles according to claim 6, further comprising:
a unit for adjusting an angle between the nozzles;
a unit for adjusting a distance between the nozzles; and
a unit for adjusting a flow rate of solutions discharged from the nozzles.

8. The apparatus for producing fine silver particles according to claim 6, wherein an outlet of each of the nozzles has either a cylindrical shape or a slit shape.

9. A method for producing fine silver particles by reducing a silver ammine complex and depositing fine silver particles comprising:
adding an alkali substance to a reducing agent solution; and
mixing the reducing agent solution with an aqueous silver ammine complex solution within a region where an oxidation-reduction potential of the reducing agent solution is stable, thereby depositing fine silver particles.

10. The method for producing fine silver particles according to claim 9,
wherein the region where an oxidation-reduction potential of the reducing agent solution is stable corresponds to a region that ranges from a point where an oxidation-reduction potential of the reducing agent solution is 0.02 V higher than a minimum value of the oxidation-reduction potential; down to the minimum value; and then up to a range where the oxidation-reduction potential remains relatively constant.

11. The method for producing fine silver particles according to claim 9,
wherein the aqueous silver ammine complex solution having a silver concentration of 20 to 180 g/L and an organic reducing agent solution having a reducing agent concentration of about 0.6 to about 1.4 times the silver concentration by reaction equivalent are used.

12. The method for producing fine silver particles according to claim 9,
wherein fine silver particles having a mean particle size of primary particles within a range of 0.05 μm to 1.0 μm and crystallite size within a range of 20 nm to 150 nm are deposited.

13. The method for producing fine silver particles according to claim 9, further comprising:
recovering deposited fine silver particles; and
subjecting recovered particles to an alkali cleaning process at a pH of 10 to 15, thereby reducing organic impurities to 0.8 wt. % or less based on a carbon content.
